(19) United States
(12) Patent Application Publication
(10) Pub. No.: US 2018/0128047 A1
(43) Pub. Date: May 10, 2018

(54) IDLE END FOR ROLLER BLIND

(71) Applicant: ZMC Metal Coating Inc., Woodbridge (CA)

(72) Inventor: Philip Ng, Thornhill (CA)

(21) Appl. No.: 15/719,509

(22) Filed: Sep. 28, 2017

Related U.S. Application Data
(60) Provisional application No. 62/419,712, filed on Nov. 9, 2016.

(51) Int. Cl. E06B 9/50

(52) U.S. Cl. CPC E06B 9/50

(57) ABSTRACT

An idle end for a roller blind comprises a bracket portion configured for securing to a surface and for supporting a roller tube shaft of a roller tube of the roller blind, a ball receiver, a housing securable to the bracket portion and retaining the ball receiver adjacent to the bracket portion; and a centralizing anti-rattle bearing. The ball receiver has a longitudinal bore with the roller tube shaft releasably receivable within the longitudinal bore. The bearing is receivable within the housing and adjacent to a surface of the ball receiver. The bearing applies a compressive force to the ball receiver helping to centralize and resist movement of the ball receiver within the housing.

### TECHNICAL FIELD

The invention relates to roller blinds and hardware for use in association with roller blinds.

### BACKGROUND

Roller blinds are a popular method to limit the intrusion of light through a window or other opening. Roller blinds can also be useful when positioned about a window for thermal and sound insulating purposes.

Roller blinds are typically comprised of a fabric or similar material wound about a roller tube. The roller tube is suspended between two end brackets that are mounted on or about a window frame. Commonly, one of the end brackets houses or has otherwise associated with it the blind's primary drive mechanism (which may include a return spring, clutch, etc.). The other or opposite end bracket is typically an idle end which merely serves to support the end of the roller blind and provide a bearing mechanism into which a rotating shaft on the end of the roller tube can be received.

Installation of a typical roller blind first requires the two end brackets to be rigidly secured in place within or about the window frame. Thereafter the roller tube shaft is inserted into the idle end and the opposite end of the roller blind then secured to the opposite end bracket. To help facilitate the receipt of the roller tube shaft into the idle end, idle ends are often fitted with a rotating ball type structure that permits the longitudinal bore within which the shaft is received to be oriented at a declined angle. With the longitudinal bore in a declined orientation, an installer can insert the roller tube shaft into the bore while standing on the floor surface without the need to work from a ladder. Unfortunately, while such idle ends can be beneficial in terms of the installation of the roller blind, the design of the rotating ball structure that facilitates installation can also result in a “loose” structure that can cause rattling and noise doing operation of the roller blind.

### SUMMARY

There is provided an idle end for a roller blind, the idle end comprising a bracket portion for securing to a surface and for supporting a roller tube shaft of a roller tube of the roller blind; a ball receiver, said ball receiver having a longitudinal bore, the roller tube shaft releasably receivable within the longitudinal bore; a housing securable to said bracket portion and retaining said ball receiver adjacent to said bracket portion; and a centralizing anti-rattle bearing, said bearing receivable within said housing and adjacent to a surface of said ball receiver, said bearing applying a compressive force to said ball receiver helping to centralize and resist movement of said ball receiver within said housing.

### BRIEF DESCRIPTION OF THE DRAWINGS

For a better understanding of the present invention, and to show more clearly how it may be carried into effect, reference will now be made, by way of example, to the accompanying drawings which show exemplary embodiments of the present invention in which:

FIG. 1 is an upper front perspective view of a typical roller blind.

FIG. 2 is a front view of the roller blind shown in FIG. 1 with the blind fabric substantially received above the roller tube.

FIG. 3 is view similar to FIG. 2 wherein the roller tube shaft has been received within the idle end and the opposite end of the roller tube not yet secured to the opposite end bracket.

FIG. 4 is an upper front perspective view of an idle end bracket in accordance with an embodiment of the invention.

FIG. 5 is a front view of a prior art idle end bracket.

FIG. 6 is a sectional line taken along the line 6-6 of FIG. 5.

FIG. 7 is an enlarged detailed view of portion A shown in FIG. 6.

FIG. 8 is an exploded view of the idle end bracket of FIG. 4.

FIG. 9 is a front view of the end bracket of FIG. 4.

FIG. 10 is a sectional view taken along the line 10-10 of FIG. 9.

FIG. 11 is a detailed view of portion A of FIG. 10.

FIG. 12 is a front view of the idle end bracket of FIG. 4 wherein the ball receiving structure is oriented downwardly.

FIG. 13 is a sectional view taken along the line 13-13 of FIG. 12.

FIG. 14 is a detailed view of portion A of FIG. 13.

### DETAILED DESCRIPTION

The present invention may be embodied in a number of different forms. The specification and drawings that follow describe and disclose some of the specific forms of the invention.

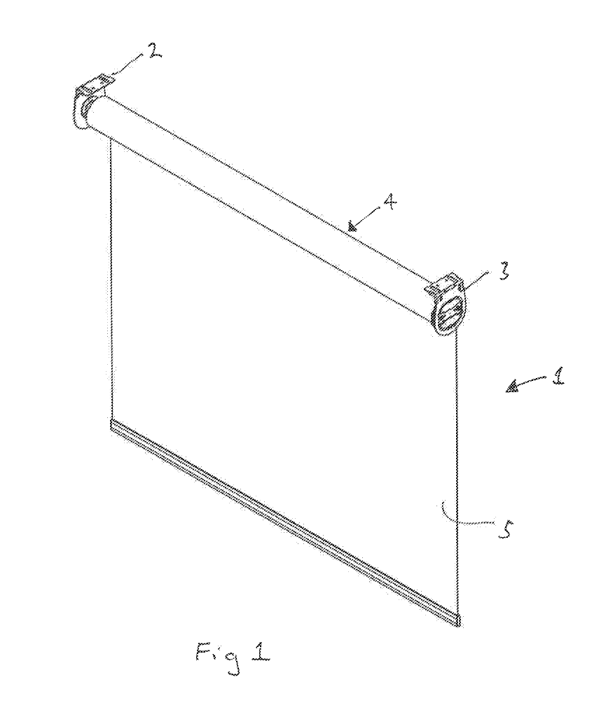

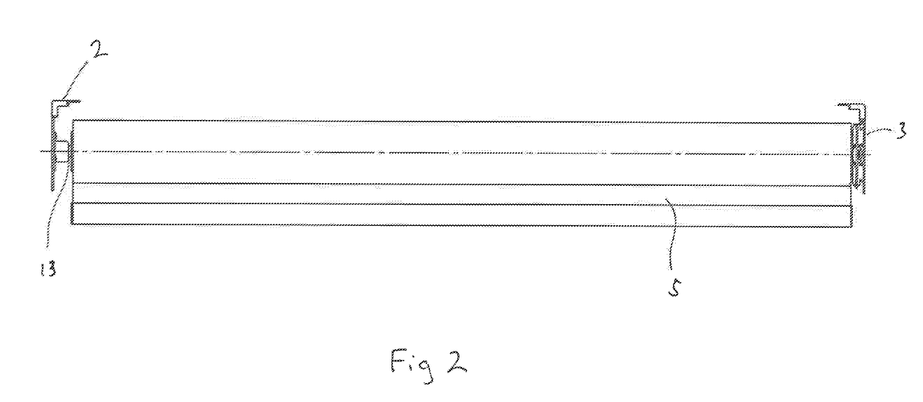

FIGS. 1 through 3 show a relatively standard roller blind 1 comprised of a pair of end brackets 2 and 3. Typically end bracket 2 would be in the form of an idle end bracket, while end bracket 3 is an operational end bracket that contains or has secured to it the drive mechanism clutch, etc. of the roller blind. Secured between the two end brackets is a roller tube 4 having wound about it blind fabric 5.

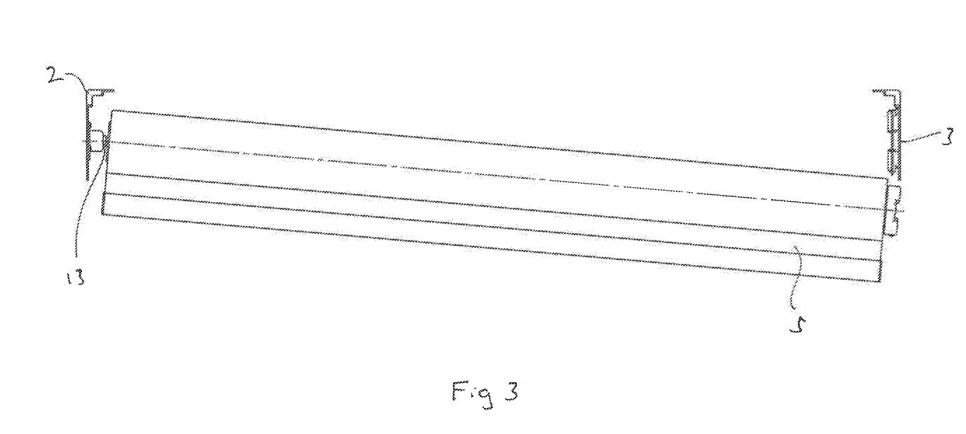

FIG. 4 depicts an upper front perspective view of an idle end bracket 2 constructed in accordance with an embodiment of the invention. With reference to FIG. 8, there is depicted an exploded view of the idle end bracket shown in FIG. 4. Idle end bracket 2 is comprised generally of a bracket portion or member 6 having secured to it a housing 7. In the particular embodiment shown, housing 7 is secured to bracket member 6 through the use of a plurality of rivets 8, however, it will be appreciated that a wide variety of other fasteners or fastening mechanisms can equally be utilized. Housing 7, in conjunction with bracket member 6, forms an enclosure for retaining a ball receiver 9. Ball receiver 9 is substantially spherical in shape having a right cylindrical extension 10 that extends through an outer opening 11 within housing 7. A longitudinal bore 12 extends through cylindrical extension 10 and into the spherical portion of ball receiver 9. As will be appreciated from a thorough understanding of the invention, bore 12 is designed to releasably receive a roller tube end shaft 13 of roller tube 4. Upon rotation of the roller tube, the end shaft may rotate within bore 12 or, alternatively, ball receiver 9 may rotate, together with the roller tube end shaft, within housing 7.

Ball receiver 9 and housing 7 effectively operate as a ball and socket structure, wherein the ball receiver can rotate about a horizontal plane in the embodiments shown in the attached drawings, and wherein the ball receiver can also be tipped in a vertical plane. With specific reference to FIGS. 3 and 12 through 14, there is demonstrated the positioning of ball receiver 9 when it is tipped in a downward direction to facilitate the receipt or the removal of roller tube end shaft 13 from bore 12. With the ball receiver tipped in a downward direction, bore 12 will also be oriented in a slightly downward direction which will assist in allowing an installer to both locate and insert roller tube end shaft 13 within bore 12. Thereafter, the roller tube can be lifted to secure its opposite end to end bracket 3, all the while ball receiver 9 rotating back upwardly into a generally horizontal orientation.

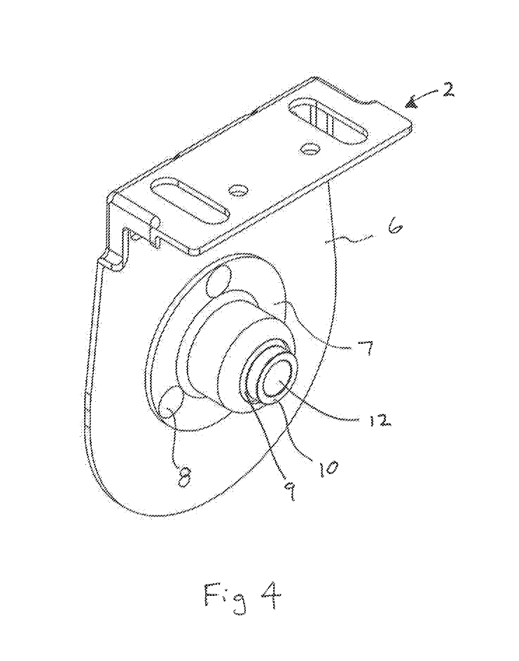

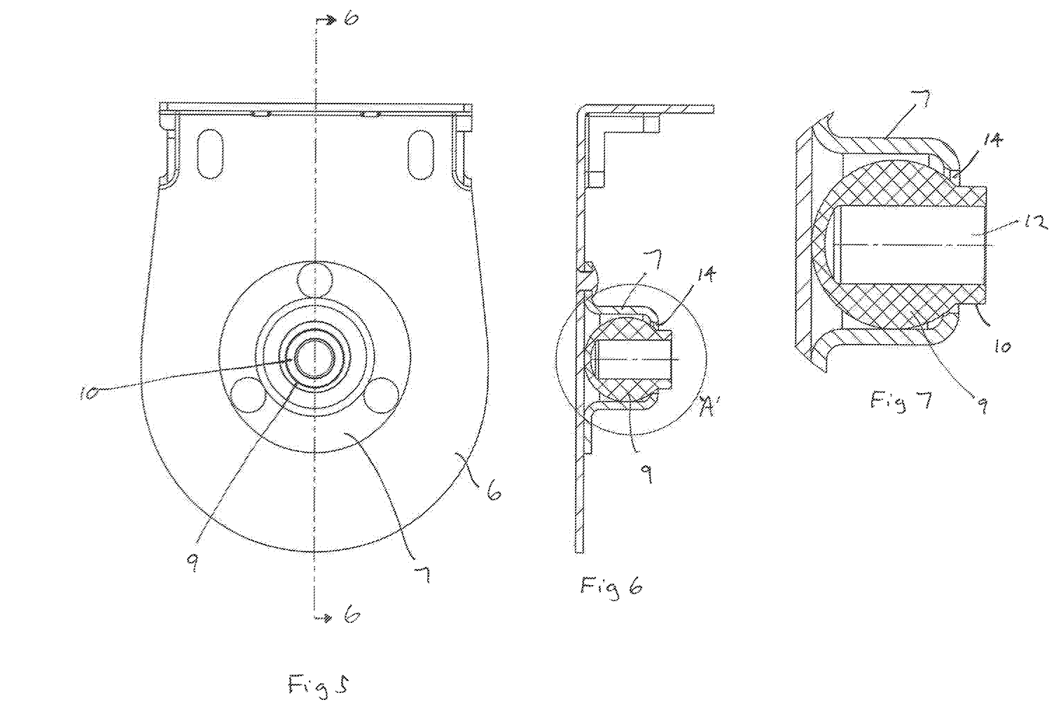

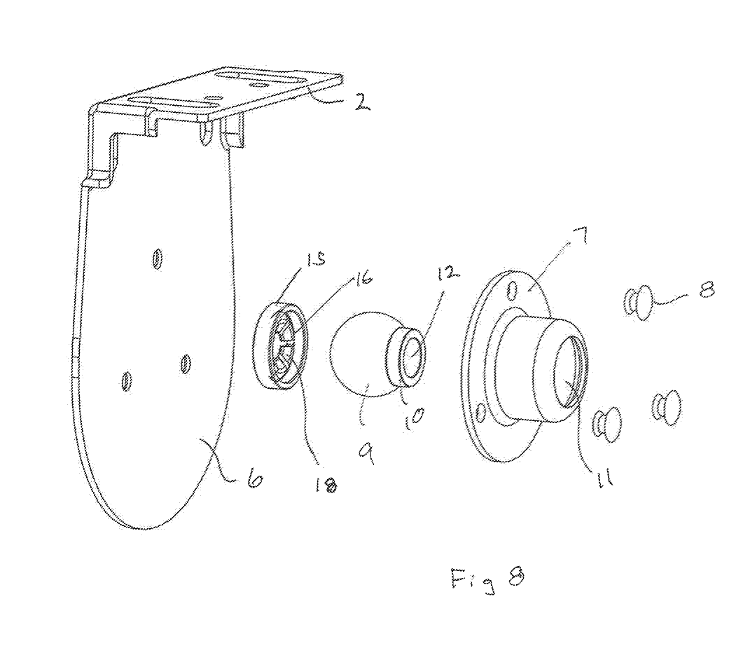

FIGS. 5 through 7 depict an embodiment of ball receiver 9 and housing 7 where the ball receiver is somewhat “loosely” held within the receiver housing. In this embodiment the ball receiver both holds the end of the roller blind in place and permits it to rotate as blind fabric is wound or unwound from the roller tube. The somewhat “loose” location of the ball receiver within the receiver housing creates a gap 14 between the top of opening 11 in housing 7 and the surface of the ball receiver. It will be appreciated that in some instances during operation of the roller blind, that gap can result in the ball receiver “jumping” within the housing or rotating in a somewhat erratic manner. Any such “jumping” or erratic rotation can cause uneven wear upon the ball receiver, undo friction on particular components, and may cause an undesirable rattling noise.

In accordance with the invention there is further provided a centralizing anti-rattle bearing 15 positioned within housing 7 and adjacent to a surface of ball receiver 9. In the particular embodiment shown in the attached drawings, bearing 15 is located at the inner most portion of housing 7 and directly adjacent to the surface of idle end bracket 2. Bearing 15 is designed to apply a compressive force to ball receiver 9 when bearing 15 and ball receiver 9 are secured against idle end bracket 2 by housing 7. The compressive force that is applied helps to both centralize the ball receiver within the housing and to a certain degree resist movement of the ball receiver.

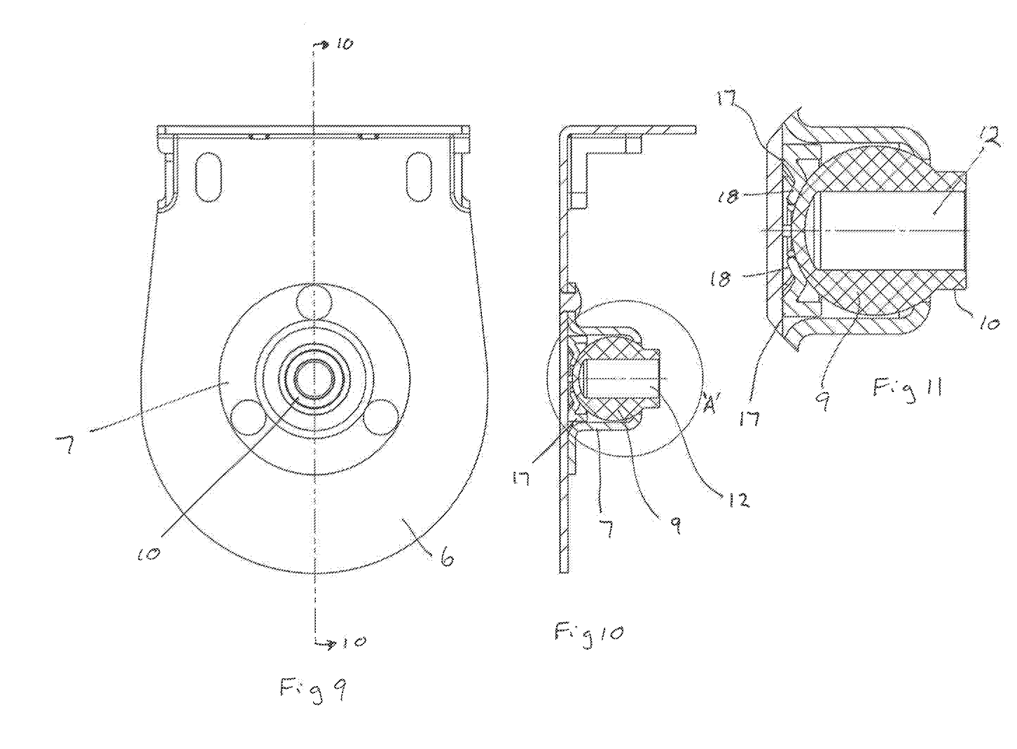

Bearing 15 may be of a generally cylindrical configuration having a concave surface 16 which is received about a portion of the exterior of ball receiver 9. The rear most surface 17 of bearing 15 abuts against the surface of bracket member 6 in order to “set off” the ball receiver from the surface of the bracket. Further, bearing 15 may include a plurality of flexibly resilient arms 18 that are displaced from a rest position when ball receiver 9 is within housing 7 and housing 7 secured to bracket member 6 (see FIGS. 10 and 11). In such a configuration arms 18 apply a compressive force to ball receiver 9, to assist in centralizing the ball receiver within housing 7. As shown in FIG. 11, with bearing 15 in place and arms 18 applying a compressive force to the exterior surface of the ball receiver, the ball receiver is generally centralized within opening 11 such that gap 14 no longer exists. With the ball receiver centralized within the housing and held relatively tightly in place, “jumping” or erratic movement of the ball receiver within the housing is eliminated or minimized, as is the resultant rattling or noise that can be created.

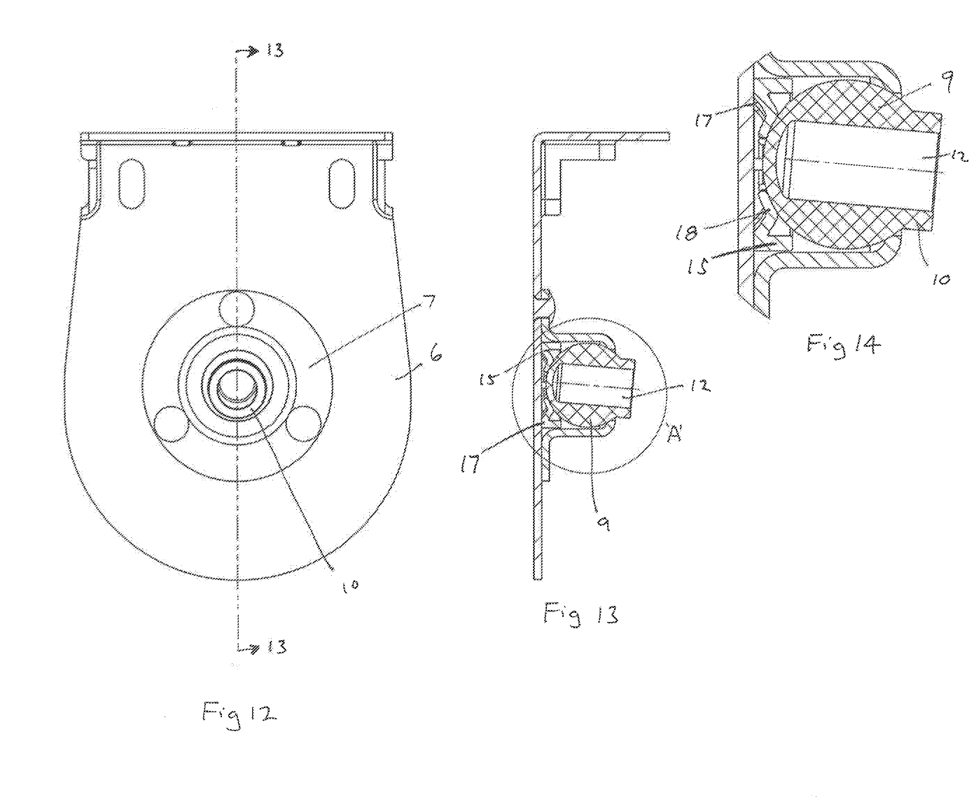

As demonstrated in FIGS. 12 and 13, the incorporation of bearing 15 continues to permit the tipping of ball receiver 9 in a downward direction to orient bore 11 in a declined angle, thereby helping to facilitate the entry or removal of roller tube end shaft 13 into or from bore 12.

It will be appreciated that both ball receiver 9 and bearing 15 could be constructed from a wide variety of different materials. In one particular embodiment, the ball receiver is formed from a plastic, nylon or similar material that helps to reduce friction from contact with housing 7, and at the same time helps to minimize noise upon movement. In the case of bearing 15, it too may be formed of a nylon, plastic or similar material that permits arms 19 to be flexibly resilient. In a further embodiment, the entire bearing may be formed from a compressible material such that the compressive force applied by bearing 15 to ball receiver 9 is a function of the resiliency of the bearing itself. In such an instance the bearing need not necessarily be equipped with individual arms, but rather an entire contact surface of the bearing may be compressed.

Other variations and embodiments of the invention will be appreciated by one of ordinary skill in the art from a review and understanding of the description and drawings.

It is to be understood that what has been described are the preferred embodiments of the invention. The scope of the claims should not be limited by the preferred embodiments set forth above, but should be given the broadest interpretation consistent with the description as a whole.

I claim:

1. An idle end for a roller blind, the idle end comprising:
a bracket portion configured for securing to a surface and for supporting a roller tube shaft of a roller tube of the roller blind;
a ball receiver, said ball receiver having a longitudinal bore, the roller tube shaft releasably receivable within the longitudinal bore;
a housing securable to said bracket portion and retaining said ball receiver adjacent to said bracket portion; and
a centralizing anti-rattle bearing, said bearing receivable within said housing and adjacent to a surface of said ball receiver, said bearing applying a compressive force to said ball receiver helping to centralize and resist movement of said ball receiver within said housing.

2. The idle end as claimed in claim 1 wherein said bearing is generally circular having a concave surface for receiving a portion of the exterior of said ball receiver therein.

3. The idle end as claimed in claim 2 wherein said bearing includes a plurality of flexibly resilient arms, said arms displaced when said ball receiver is retained adjacent to said bracket portion by said housing, said arms applying a compressive force to said ball receiver when so displaced.

4. The idle end as claimed in claim 3 wherein said bearing is comprised of a compressible material.

5. The idle end as claimed in claim 3 wherein said flexibly resilient arms are positioned within said concave surface and bear against the exterior surface of said ball receiver when said housing retains said ball receiver adjacent to said bracket portion.

6. The idle end as claimed in claim 2 wherein said bearing is comprised of a resiliently compressible material, said bearing compressed when said ball receiver is retained adjacent to said bracket portion by said housing, said compressed bearing applying a compressive force to said ball receiver when so displaced.
